(19) United States
(12) Patent Application Publication
(10) Pub. No.: US 2013/0145804 A1
(43) Pub. Date: Jun. 13, 2013

(54) LOCK DEVICE

(71) Applicants: Sadao Yamakage, Nagoya-shi (JP); Keiichi Araki, Nagoya-shi (JP)

(72) Inventors: Sadao Yamakage, Nagoya-shi (JP); Keiichi Araki, Nagoya-shi (JP)

(73) Assignees: TOMOE SYSTEM INC., Kobe-shi ,Hyogo (JP); SANKYO KINZOKU CO., LTD., Nagoya-shi ,Aichi (JP)

(21) Appl. No.: 13/807,997

(22) PCT Filed: Aug. 9, 2011
(86) PCT No.: PCT/JP2011/068158

§ 371 Date: Mar. 1, 2013

(30) Foreign Application Priority Data
Sep. 7, 2010 (JP) 2010-199805

(51) Int. Cl. E05B 29/00

(52) U.S. Cl. CPC E05B 29/0033
USPC 70/492

(57) ABSTRACT

A lock device (10) is used with a flat key (K) having asymmetric opposite edges (3, 4). The lock device (10) includes a key rotor (14) which is configured to have distances from a central axis line (O2) of the key (K) to abutment points of the edges (3, 4) against the tumbler (32a-32c) respectively, and the distances are set so as to equal each other such that the non-reversible key is capable of reversible use in an inserted state of the key (K) into a key insertion hole (23).

### TECHNICAL FIELD

The present invention relates to a lock device for use with a non-reversible key including two flat-plate-shaped edges having asymmetric profiles.

### BACKGROUND ART

A lock device has conventionally been provided on door panels together with a door lock mechanism in vehicles such as automobiles, for example. The same lock devices have also been provided in a steering column, a fuel filler opening and the like of the vehicles. A single key is co-used for these lock devices in the vehicles as well known in the art.

Differing from reversible keys, the key of the above-described type sometimes has opposite edges of a key body or shank formed into asymmetric shapes as described above. When locking and unlocking are carried out with the asymmetric key, a user needs to insert the key into a key-insertion hole of the lock device with a correct orientation. More specifically, when the key is inserted with an incorrect orientation and forced to be turned in a half inserted state, there is a possibility that the key may be deformed or broken, or the rotor side of the lock device may be broken, for example. (See Patent Document 1 regarding the reversible keys and asymmetric keys.)

### PRIOR ART DOCUMENT

### Patent Document

Patent Document 1: JP-A-H07-279504

### SUMMARY OF THE INVENTION

### Problem to be Overcome by the Invention

However, in introducing the above-described non-reversible key, the hitherto used key cannot naturally be used and accordingly, all the lock devices of the vehicle need to be replaced by new ones adapted to the new key. This results in a problem of high replacement costs.

The present invention was made in view of the foregoing problem and an object thereof is to provide a lock device which can prevent deformation and breakage of the key and/or a key rotor without replacement of the key and which can reduce the replacement costs of the key device as low as possible.

### Means for Overcoming the Problem

To achieve the above-described object, the present invention provides a lock device for use with a flat plate-shaped non-reversible key including two edges having respective asymmetric profiles, the lock device being usable with a rotor case having a key rotor accommodating portion and a tumbler engagement groove formed in a surface thereof facing the key rotor accommodating portion, the lock device comprising a key rotor rotatably mounted in the key rotor accommodating portion and having an axially extending key insertion hole and a radially extending tumbler disposition groove; and a tumbler movably disposed in the tumbler disposition groove and biased toward a radially peripheral side with respect to the key rotor by a biasing member so that an outer periphery of the tumbler is moved from the tumbler disposition groove to the tumbler engagement groove side to engage the tumbler engagement groove, thereby blocking the key rotor from rotative movement, the key being removably insertable into the key insertion hole so that either edge abuts against the tumbler in an inserted state of the key to move the tumbler into the tumbler disposition groove, whereby the key rotor is allowed to be rotatively moved, wherein the key rotor is configured to have distances from a central axis of the key to abutment points of the edges against the tumbler respectively, the distances being set so as to equal each other even when the key is inserted into the key insertion hole while assuming either normal or reverse orientation, whereupon the non-reversible key is capable of reversible use.

### Effect of the Invention

According to the above-described construction, even when the non-reversible key is inserted with the normal or reverse orientation, the distances from the central axis of the key to abutment points of the tabular edges against the tumbler respectively are set so as to be equal to each other. Consequently, although the key is of a non-reversible type, the key has no limitation in the orientation of the key to be inserted into the key insertion hole. When the key is inserted into the key insertion hole, either edge can move the tumblers into the respective tumbler disposition grooves. Consequently, application of the above-described lock device can overcome the problem that the key in a wrong orientation is inserted into the key insertion hole, whereupon the key and/or the key rotor can be prevented from deformation.

Since the lock device according to the invention is configured to be used with a non-reversible key, a hithereto used key can be used with the lock device in a reversible manner without replacement. Accordingly, even when the key is co-used between or among a plurality of lock devices, only a desirable one of the lock devices needs to be replaced by the lock device according to the invention, and thus, not all the lock devices need to be replaced. This can reduce the replacement costs to minimum.

### BRIEF DESCRIPTION OF THE DRAWINGS

FIG. 1 is an exploded perspective view of the lock device of one embodiment in accordance with the present invention together with a key;

FIG. 2 is a longitudinal side section of a key rotor accommodated in a rotor case;

FIG. 3A is a plan view of the key;

FIG. 3B is a rear view of the key;

FIG. 3C is a view of the key as viewed from the direction of a central axis line;

FIG. 4A is a longitudinal front section of the key inserted into a key insertion hole in a first orientation;

FIG. 4B is a longitudinal side section of the key inserted into the key insertion hole in the first orientation;

FIG. 5A is a view similar to FIG. 4A, showing the key inserted into the key insertion hole in a second orientation; and

FIG. 5B is a view similar to FIG. 4B, showing the key inserted into the key insertion hole in the second orientation.

### EXPLANATION OF SYMBOLS

In the drawings, reference symbols 1a and 1b designate grooves, 3 and 4 edges, 10 a lock device, 11 a rotor case, 23 a key insertion hole, 30a and 30b guides, 31a to 31c tumbler disposition grooves, 32a to 32c tumblers, 33a to 33c biasing members, K a key, 02 a central axis line, Pa to Pc and Pa′ to Pc′ abutment points, La to Lc and La′ to Lc′ distances and P1 and P2 pitches.

### BEST MODE FOR CARRYING OUT THE INVENTION

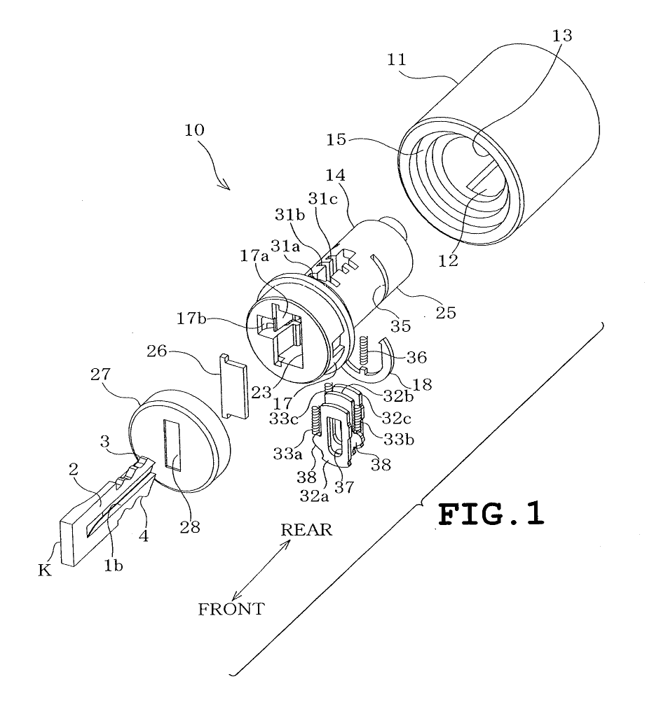

An embodiment will be described with reference to FIGS. 1 to 5B. In the embodiment, the invention is applied to a vehicle such as an automobile. The side where an operator is located in front of a lock device 10 is referred to as “front” and the side opposite the front is referred to as “rear” throughout the description.

The lock device 10 includes a rotor case 11 incorporated into a lock body lateral to a steering column of a vehicle, for example although the lock body and the steering column are not shown. The rotor case 11 is formed into a generally cylindrical shape and has an inner peripheral wall 13 defining an interior serving as a key rotor housing. The inner peripheral wall 13 has two axially extending tumbler engagement grooves 12 formed at an interval of 180° so as to be opposed to each other.

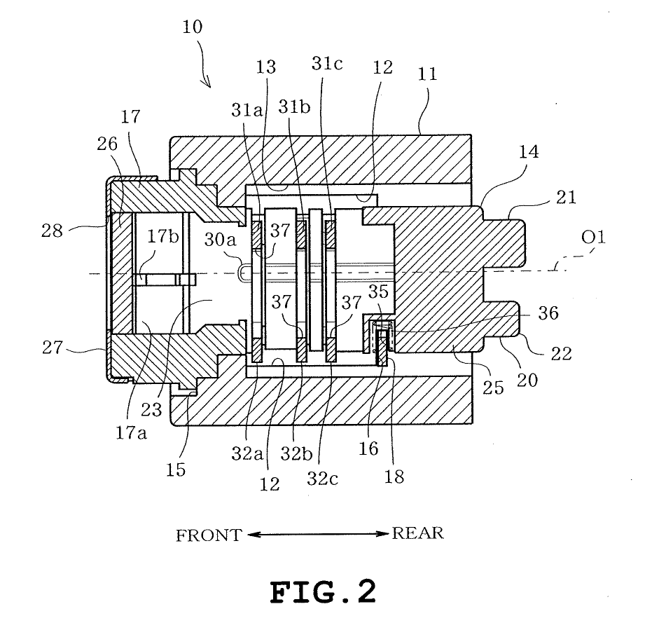

The key rotor housing 13 is formed with a front step 15 and a rear step 16 (see FIG. 2) both locking a key rotor 14 and the like in a front-back direction, whereby the key rotor housing 13 is stepped. In more detail, the front step 15 is located in a front part of the key rotor housing 13 to lock a flange 17 of the key rotor 14 when the key rotor 14 is accommodated in the key rotor housing 13. The rear step 16 is located in a rear part of the key rotor housing 13 to lock a stopper ring 18 when the key rotor 14 is accommodated in the key rotor housing 13.

A locking mechanism is disposed in the rear of the rotor case 11 although not shown. The locking mechanism is adapted to be connected to a rear end (a connection 20) of the key rotor 14. The lock device 10 is incorporated in the lock body so as to be connected to the locking mechanism. The lock device 10 turns on and off an ignition switch (not shown) to start and stop an engine and for other purposes.

The key rotor 14 is rotatably mounted in the key rotor housing 13 and has a key insertion hole 23 defined by an inner peripheral wall thereof. The key rotor 14 is made of a metal material and includes a generally columnar rotor body 25, a flange 17 formed on a front end of the rotor body 25 and the connection 20 formed on a rear end of the rotor body 25 all of which are formed integrally with the key rotor 14.

The rotor body 25 has an outer peripheral surface which is formed so as to be brought into sliding contact with an inner peripheral surface of the rotor case 11. The rotor body 25 is inserted from a front thereof into the rotor case 11. The connection 20 includes a pair of upper and lower protrusions 21 and 22 protruding rearward from the rear end of the rotor body 25.

The flange 17 is formed so as to cover the front surface of the key rotor housing 13 and has a front end to which a cap 27 is attached from the front with a generally rectangular plate-shaped shutter 26 being disposed on the front end of the flange 17. In more detail, the cap 27 is formed with a key insertion opening 28 communicating with the key insertion hole 23. The flange 17 has a shutter accommodation recess 17a and a spring accommodation recess 17b both formed in the front thereof so as to be recessed rearward. The shutter 26 is pivotally mounted on the front of the flange 17 so as to open and close the shutter accommodation recess 17a. The shutter 26 is biased by a torsion coil spring (not shown) in a direction such that the shutter 26 closes the key insertion opening 28. The shutter 26 is configured to allow the key K to be inserted through the key insertion opening 28 when opening the insertion opening 28. The torsion coil spring is accommodated in the spring accommodation recess 17b.

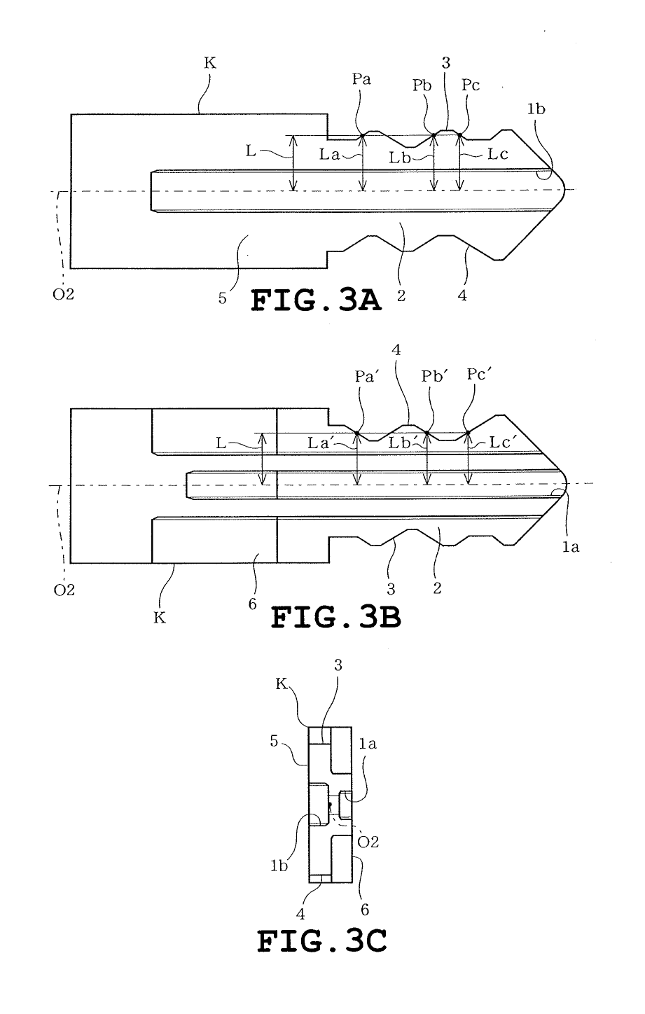

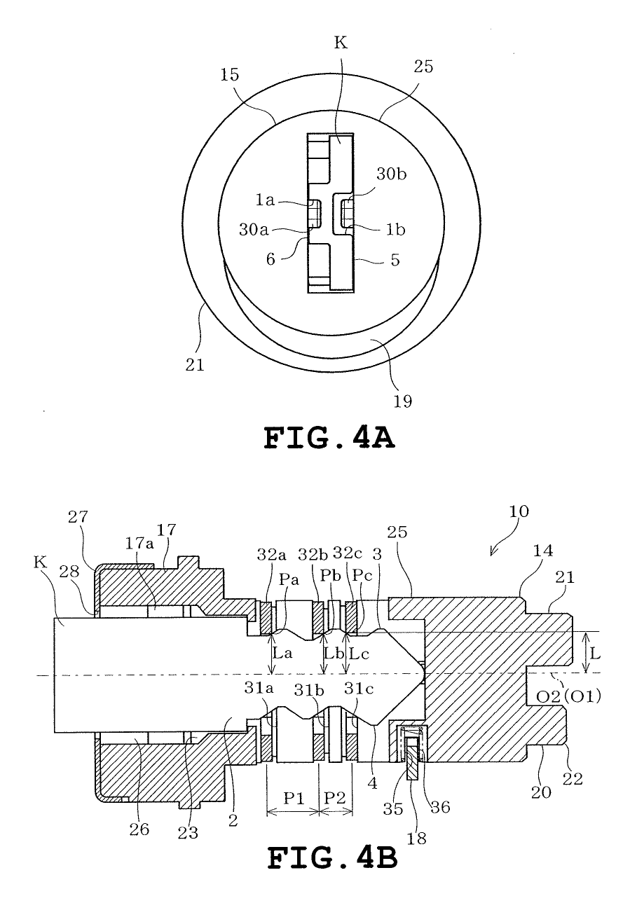

The key insertion hole 23 extends axially with respect to the key rotor 14 (in the direction of the central axis line (see FIG. 2) about which the key rotor 14 directed in the front-back direction pivots). The key insertion hole 23 is formed into a vertically long generally rectangular shape as viewed in a front view. The inner peripheral wall defining the key insertion hole 23 is formed with a pair of inwardly protruding guides 30a and 30b each extending along the central axis line 01 (see FIGS. 2 and 4A). The guides 30a and 30b are formed into the same shape and are located on the inner peripheral wall of the key rotor 14 defining the key insertion hole 23 so as to be symmetric with respect to the central axis line O1 (bilaterally symmetric in the embodiment). Furthermore, the guide 30a is sized so as to be fitted in the groove 1a and the guide 30b is sized so as to be loosely fitted in the groove 1b when the key K has been inserted into the key insertion hole 23, as shown in FIGS. 3A to 3C. The key K will be described in detail later.

The rotor body 25 has a plurality of, for example, three tumbler disposition grooves 31a to 31c which are formed so as to radially extend therethrough and so as to be axially lined with respect to the rotor body 25. Each of the grooves 31a to 31c is formed into a rectangular shape as axially viewed (from above in FIG. 1, for example) and communicates with the key insertion hole 23. The grooves 31a to 31c are provided with tumblers 32a to 32c which are movably disposed, respectively. Counterbores for spring members 33a to 33c as shown in FIG. 1 are formed so as to correspond to the tumbler disposition grooves 31a to 31c respectively although not shown in the drawings. The tumblers 32a to 32c are biased radially outward from the tumbler disposition grooves 31a to 31c by the spring members 33a to 33c serving as biasing members respectively. As shown in FIG. 2, the tumblers 32a to 32c have outer peripheries which are located out of the tumbler disposition grooves 31a to 31c to the tumbler engagement groove 12 side thereby to engage the tumbler engagement grooves 12 respectively, whereby the key rotor 14 is prevented from rotative movement.

The rotor body 25 has a stopper disposition groove 35 located in the rear of the tumbler disposition grooves 31a to 31c. The generally C-shaped stopper ring 18 is movably disposed in the groove 35. The stopper ring 18 is biased radially outward by a spring member 36 disposed on a lower end of the groove 35. When the stopper ring 18 projecting from the groove 35 is engaged with the rear step 16 of the key rotor housing 13, the key rotor 14 is locked so as to be immovable forward.

FIGS. 3A to 3C exemplify the key K of the lock device 10 of the embodiment. The key K as shown in FIGS. 3A to 3C has a central axis line O2 that is a lengthwise center line corresponding to the central axis line O1 of the key rotor 14 in the case where the key K has been inserted in the key insertion hole 23.

The key K includes an insertion portion or a shank 2 serving as a flat plate-shaped key body and a head (not shown) located at an end of the shank 2 (the left side as viewed in FIGS. 3A and 3B). The shank 2 has opposite edges 3 and 4 formed with respective profiles of notches or cuts. The edges 3 and 4 are asymmetric about the central axis line O2. Each of the edges 3 and 4 is widthwise (that is, in the direction perpendicular to the central axis line O2) concave and convex into a stepped shape, as shown in FIGS. 3A and 3B. Furthermore, each of the edges 3 and 4 has no steps in the direction of thickness of the key K (that is, in the direction perpendicular to the plane of FIGS. 3A and 3B) to be substantially even and relatively simple.

The shank 2 of the key K has both sides 5 and 6 with respect to the direction of thickness thereof. The sides 5 and 6 have respective grooves 1a and 1b which extend lengthwise along the central axis line O2 and occupy plane-symmetric positions. The grooves 1a and 1b are formed in widthwise central portions of the shank 2, for example. The groove 1a has a smaller width than the other groove 1b and is guided by either guide 30a or 30b. The key K has been used with another lock device (hereinafter, “conventional lock device”) differing from the lock device 10 as will be described in more detail later. Each of the edges 3 and 4 is convex and concave so that the heights of each edge's portions corresponding to tumblers of the conventional lock device differ from one another. In other words, differing from a reversible key, the key K is of a non-reversible type that has a restriction of the orientation with which the key is inserted into a key insertion hole in the conventional lock device.

The lock device 10 of the embodiment is capable of rendering the asymmetric key K usable as a reversible key.

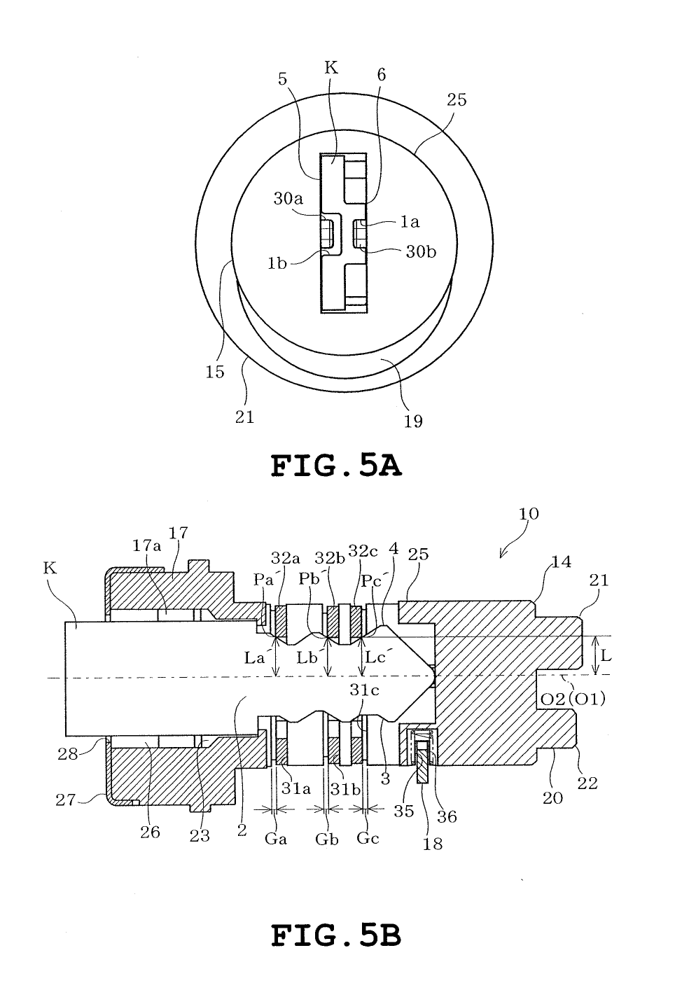

Concrete constructions of the key rotor 14 and the tumblers 32a to 32c for conversion into the reversible key will now be described with reference to FIGS. 4A to 5B as well as with FIGS. 1 to 3. A first orientation refers to a state (see FIG. 4A) in which the key K is inserted with a side 5 thereof constituting a right side and the edge 3 abuts against the tumblers 32a to 32c in the inserted state of the key K. Furthermore, a second orientation refers to a state (see FIG. 5A) in which the key K is inserted with the other side 6 thereof constituting a right side and the edge 4 abuts against the tumblers 32a to 32c in the inserted state of the key K.

Firstly, the tumblers 32a to 32c are, for example, thin-plate shaped disc tumblers and have the same dimensions as shown in FIG. 1. The tumblers 32a to 32c have holes 37 through which the key K is inserted and protrusions 38 which engage corresponding spring members 33a to 33c, respectively. The tumblers 32a to 32c are disposed so that the protrusions 38 (or the spring members 33a to 33c) of the adjacent tumblers are located opposite each other.

FIG. 4B shows the key K which is inserted into the key insertion hole 23 while assuming the aforementioned first orientation. As shown, reference symbol La designates a distance between a central axis line O2 and an abutment point

Pa of the edge 3 against the tumbler 32a. Reference symbol Lb designates a distance between the central axis line O2 and an abutment point Pb of the edge 3 against the tumbler 32b. Reference symbol Lc designates a distance between the central axis line O2 and an abutment point Pc of the edge 3 against the tumbler 32c. The distances Pa, Pb and Pc are set so as to have the same length L (La=Lb=Lc=L). Each of the aforementioned distances Pa to Pc has a line segment extending in a direction perpendicular to the central axis line O2 and corresponding to a widthwise direction of the key K (a radial direction of the key rotor 14). Accordingly, the edge 3 of the key K abuts against the tumblers 32a to 32c of the same shape thereby to move the tumblers to the respective tumbler disposition grooves 31a to 31c, whereby the key rotor 14 is allowed to be rotated.

On the other hand, FIG. 5B shows the key K which is inserted into the key insertion hole 23 while assuming the second orientation. As shown, reference symbol La′ designates a distance between the central axis line O2 and an abutment point Pa′ of the edge 4 against the tumbler 32a. Reference symbol Lb′ designates a distance between the central axis line O2 and an abutment point Pb′ of the edge 4 against the tumbler 32b. Reference symbol Lc′ designates a distance between the central axis line 02 and an abutment point Pc' of the edge 4 against the tumbler 32c. The distances Pa′, Pb′ and Pc′ are also set so as to have the same length L′ (La′=Lb′=Lc′=L) in the same manner as described above. Accordingly, the edge 4 of the key K abuts against the tumblers 32a to 32c thereby to move the tumblers to the respective tumbler disposition grooves 31a to 31c in the same manner as described above.

More specifically, the tumbler disposition grooves 31a to 31c are located axially with respect to the key rotor 14 so that the distances L between the central axis line O2 and the abutment points Pa to Pc equal one another and so that the distances L between the central axis line O2 and the abutment points Pa′ to Pc′ equal one another. To be more exact, the tumbler disposition grooves 31a to 31c have gaps Ga to Gc serving as allowances for the tumblers 32a to 32c, respectively, as shown in FIG. 5B. Accordingly, the tumblers 32a to 32c are displaced by the gaps Ga to Gc in the tumbler disposition grooves 31a to 31c in the relationship to inclination at the abutment points Pa to Pc and Pa′ to Pc′ of the edges 3 and 4, respectively. In view of the gaps of the tumblers 32a to 32c, the tumbler disposition grooves 31a to 31c are located so that the aforesaid distances have such a relationship that La=La′, Lb=Lb′ and Lc=Lc′.

Thus, pitches P1 and P2 (see FIG. 4B) between the axially adjacent tumbler disposition grooves 31a to 31c differ from each other according to the configurations or profiles of the edges 3 and 4. Even in the case where the key K assumes the first or second orientation when being inserted into the key insertion hole 23, the tumblers 32a to 32c are reliably moved into the tumbler disposition grooves 31a to 31c in the inserted state of the key K. Accordingly, although the key K employs different profiles of the edges 3 and 4 on both sides respectively, the tumblers abutting against the edge 3 with the key K assuming the first orientation are the same as the tumblers abutting against the edge 4 with the key K assuming the second orientation, both being constituted by the same tumblers 32a to 32c.

Furthermore, the key insertion hole 23 is formed so that the paired guides 30a and 30b thereof are located at the symmetric positions where the guides fit into the grooves 1a and 1b of both sides 5 and 6 of the key K in the aforesaid inserted state, respectively. As a result, the key K is allowed to be inserted into the key insertion hole 23 even when assuming the first or second orientation. More specifically, the key is restricted to the forward or first orientation in the conventional lock devices when inserted into the key insertion hole. However, the lock device 10 of the embodiment is configured so that the key K is allowed to be inserted even when assuming either forward or reverse orientation, and so that the key K is guided by the guide 30a or 30b.

An assembly sequence of the lock device 10 will subsequently be described with reference to FIGS. 1 and 2. Firstly, the tumblers 32a to 32c are disposed so as to be biased by the spring members 33a to 33c at the projected portions 38 of the tumblers 32a to 32c respectively. The stopper ring 18 is also disposed in the stopper disposition groove 35 together with the spring member 36. Furthermore, the shutter 26, the cap 27 and the like are assembled to the flange 17 of the key rotor 14. The tumblers 32a to 32c and the stopper ring 18 are thrust inward so as to become co-planar with the outer periphery of the key rotor 14. In the thrust state, the key rotor 14 is accommodated into the rotor case 11 from the front side, whereupon the stopper ring 18 comes out to the rear step 16 side to engage the step, and the tumblers 32a to 32c come out to the tumbler disposition groove 12 side (lower side as viewed in FIG. 2) to engage the groove. Since the lock device 10 thus assembled has the shutter 26 attached to the cap 27, it is hard for rainwater, dust and the like to invade the interior of the lock device 10.

The above-described assembly is carried out, for example, when the conventional lock device in the lock body is to be replaced by the new lock device 10. In this case, only the key rotor 14 side may be replaced with the conventional rotor case being used, or the entire rotor case 11 may be replaced by the new key rotor 14.

The working of the lock device 10 thus constructed will now be described. FIG. 2 shows a locked state of the lock device 10. In the locked state, nothing is inserted into the key insertion hole 23, and the key rotor 14 has been rotated thereby to assume the position (a lock position) where the tumblers 32a to 32c protrude from the respective tumbler disposition grooves 31a to 31c into, for example, the lower tumbler engagement groove 12.

When the key K is inserted into the key insertion hole 23 while assuming the first orientation, the key is guided by the guide 30a in the groove 1a thereby to be moved in the direction of the central axis line 02. The tumblers 32a to 32c are moved by the edge 3 of the key K against the biasing force of the spring member thereby to be accommodated into the respective tumbler disposition grooves 31a to 31c, as shown in FIG. 4B. In this state, the key rotor 14 is allowed to be rotated together with the key K when the key K is turned. In this case, when the key K is turned clockwise to a START position (not shown) as viewed in front view, for example, engine start-up can be effected.

The key K is inserted into the key insertion hole 23 while assuming the second orientation although the shank 2 thereof has asymmetric edges 3 and 4. In this case, the key K is moved in the direction of the central axis line O2 while being guided by the guide 30b located in the groove 1a. The tumblers 32a to 32c are moved by the edge 4 of the key K so as to be accommodated into the respective tumbler disposition grooves 31a to 31c against the biasing force of the spring member as shown in FIG. 5B. Accordingly, when the key K is turned to the START position in the same manner as in the case where the key K assumes the first orientation, whereby engine start-up or the like can be effected.

As described above, even when the key K of the lock device 10 is inserted into the key insertion hole 23 while assuming either first or second orientation, the distances La to Lc and La′ to Lc′ between the central axis line O2 and the abutment points Pa to Pc and Pa′ to Pc′ of the edges 3 and 4 against the tumblers 32a to 32c are set to the same value L.

Accordingly, there is no restriction in the insertion orientation of the key K to be inserted into the key insertion hole 23. When the key K is inserted into the key insertion hole 23, the tumblers 32a to 32c can be moved into the respective tumbler disposition grooves 31a to 31c by the edges 3 and 4 thereof .

As a result, application of the lock device 10 can overcome a problem that the key K is inserted while assuming an incorrect orientation, whereupon the key K and the key rotor 14 can reliably be prevented from deformation. Thus, since the lock device 10 is configured to be adaptable to the asymmetric key K, the hitherto used key K can be used as a reversible key without replacement. Accordingly, for example, even when the key K is used in common with lock devices for door panels, a fuel filler opening of the vehicle and the like, only the lock device (the lock device mounted in the lock body of the steering column) desired to be used in the reversible manner needs to be replaced, and thus, not all the lock devices of the vehicle need to be replaced. This can reduce replacement costs to minimum.

The key rotor 14 has a plurality of tumbler disposition grooves 31a to 31c formed so as to extend axially, and a plurality of tumblers 32a to 32c is provided so as to correspond to the tumbler disposition grooves 31a to 31c respectively. The tumblers 32a to 32c have the same dimensions and the same shape.

According to the construction, the lock device can be configured more economically and more easily, and error or failure can be eliminated in the assembly of the tumblers 32a to 32c into the respective tumbler disposition grooves 31a to 31c, whereupon the workability can be improved.

The key rotor 14 has three or more tumbler disposition grooves 31a to 31c formed so as to extend axially, and three or more tumblers 32a to 32c are provided so as to correspond to the tumbler disposition grooves 31a to 31c respectively. The tumbler disposition grooves 31a to 31c are located axially with respect to the key rotor 14 so that the distances La to Lc between the central axis line O2 and the abutment points Pa to Pc equal one another and so that the distances La′ to Lc′ between the central axis line O2 and the abutment points Pa′ to Pc′ equal one another. Consequently, the pitches P1 and P2 between the axially adjacent tumbler disposition grooves 31a to 31c differ from each other.

According to the above-described settings, in the case where the pitches P1 and P2 differ from each other, the tumblers 32a to 32c can reliably be moved into the tumbler disposition grooves 31a to 31c respectively even when the key K assuming either normal or reverse orientation is inserted into the key insertion hole 23. Furthermore, since the key K is rendered usable in the reversible manner as described above, the key K assuming a wrong orientation is prevented from being inserted into the key insertion hole 23 and forcedly turned. Consequently, since the strength (rigidity) of the key rotor 14 need not be increased more than necessary, the pitch P2 can be rendered smaller with realization of reversible operation of the key, whereupon the freedom in the design of the lock device can be improved.

The paired guides 30a and 30b are formed so as to be fitted in the grooves 1a and 1b formed in both sides of the key K in the key insertion hole 23 with the key K being inserted into the hole, respectively. Furthermore, the guides 30a and 30b are formed on the inner peripheral wall of the key rotor 14 so as to be symmetric about the central axis line O2. At least one of the guides 30a and 30b is fitted in the groove 1a or 1b thereby to guide the key K to be inserted into the key insertion hole 23. According to the above-described construction, the key K assuming either normal or reverse orientation is allowed to be inserted into the key insertion hole 23 even though the key K is formed into an asymmetric shape. The key K can also be guided reliably when inserted into the key insertion hole 23.

As described above, since the conventional asymmetric key has opposite edges with different notch profiles, the key needs to be inserted into the key insertion hole of the lock device while assuming a correct orientation. In view of this, a special key configuration can be considered. More specifically, although differing from the foregoing embodiment, a pair of asymmetric keys (not shown) having the same configuration are overlapped into a single key while one of the keys assumes a first orientation and the other assumes a second orientation. However, when this special key is to be introduced, a hitherto used key will not naturally be used. In this case, all the lock devices of the vehicle need to be replaced by those suitable for the new key. This results in a problem of increase in replacement costs. Furthermore, although special, the key presents the sides of the same configuration when assuming the aforesaid first and second orientations. Thus, the key is of the reversible type that the configurations of the edges and a positional relation between the edges are maintained. Accordingly, the key naturally has no restriction in the orientation it assumes when inserted into a key insertion hole. Different tumblers suitable for the respective edges abut against paired edges having different configurations.

On the other hand, the key K used in the foregoing embodiment is formed into the asymmetric shape, that is, the side views (see FIGS. 4B and 5B) of the key differ from each other when the key assumes the first and second orientations. Furthermore, when the above-described configuration is employed, tumblers abutting against one 3 of the opposite edges of the key K and against the other 4 can be composed of the same tumblers 32a to 32c although the edges 3 and 4 have different profiles.

Accordingly, the key K can be used in the reversible manner without employment of a complicate key structure (namely, without replacement of the key K as described above). This can reduce the costs of the lock device as low as possible and can simplify the construction of the lock device together with the costs of the key and sharing of tumblers 32a to 32c.

The present invention should not be limited to the above-described embodiment but may be modified or expanded as follows. The lock device 10 of the invention can be applied to general lock devices with which keys with asymmetric edges are used.

The numbers of the tumbler disposition grooves and the tumblers may be four or more or three or less. Furthermore, when the lock device includes a plurality of tumbler disposition grooves and a plurality of tumblers, the tumblers may have different shapes. In this case, locations of the tumbler disposition grooves in the axial direction of the key rotor are set so that the distances between the central axis line O2 and the points of abutment of one of the opposite edges against the tumblers become equal to the distances between the central axis line O2 and the points of abutment of the other edge against the tumblers, according to the shapes of the tumblers in the respective tumbler disposition grooves. According to this setting manner, the pitch between axially adjacent tumbler disposition grooves can be set at any value, whereupon the key can be used in the reversible manner as in the foregoing embodiment.

The tumblers of the key rotor need not be limited to the above-described disc tumblers. Axially lined pin holes communicating with the key insertion hole may be formed and tumbler pins accommodated in the respective pin holes may be used, instead. More specifically, when the key assuming either normal or reverse orientation is inserted in use of the tumbler pins, the distances between the central axis line 02 and the points of abutment of one edge against the tumblers become equal to the distances between the central axis line 02 and the points of abutment of the other edge against the tumblers in the inserted state of the key into the key insertion hole, whereby the key can be used in the reversible manner. The biasing member may comprise any one of various types of springs other than the spring members 33a to 33c. The positions and shape of the guides may be changed according to the shapes of the grooves of the key.

1. A lock device for use with a flat plate-shaped non-reversible key including two edges having respective asymmetric profiles, the lock device being usable with a rotor case having a key rotor accommodating portion and a tumbler engagement groove formed in a surface thereof facing the key rotor accommodating portion, the lock device comprising:
a key rotor rotatably mounted in the key rotor accommodating portion and having an axially extending key insertion hole and a radially extending tumbler disposition groove; and
a tumbler movably disposed in the tumbler disposition groove and biased toward a radially peripheral side with respect to the key rotor by a biasing member so that an outer periphery of the tumbler is moved from the tumbler disposition groove to the tumbler engagement groove side to engage the tumbler engagement groove, thereby blocking the key rotor from rotative movement, the key being removably insertable into the key insertion hole so that either edge abuts against the tumbler in an inserted state of the key to move the tumbler into the tumbler disposition groove, whereby the key rotor is allowed to be rotatively moved,
wherein the key rotor is configured to have distances from a central axis of the key to abutment points of the edges against the tumbler respectively, the distances being set so as to equal each other even when the key is inserted into the key insertion hole while assuming either normal or reverse orientation, whereupon the non-reversible key is capable of reversible use.

2. The lock device according to claim 1, wherein the key rotor has a plurality of the tumbler disposition grooves formed to axially extend with respect to the key rotor, the lock device further comprising a plurality of the tumblers provided so as to correspond to the tumbler disposition grooves respectively, wherein the tumblers are equally sized.

3. The lock device according to claim 1, wherein the key rotor has not less than three axial tumbler disposition grooves with respect thereto;
three tumblers are provided so as to correspond to the tumbler disposition grooves respectively; and
the tumbler disposition grooves have respective positions set so that a first distance from the central axis to the abutment point of one edge of the key equals a second distance from the central axis to the abutment point of the other edge of the key, whereby the axially adjacent tumbler disposition grooves have pitches differing from each other between the edges of the key.

4. The lock device according to claim 2, wherein the key rotor has not less than three axial tumbler disposition grooves with respect thereto;
three tumblers are provided so as to correspond to the tumbler disposition grooves respectively; and
the tumbler disposition grooves have respective positions set so that a first distance from the central axis to the abutment point of one edge of the key equals a second distance from the central axis to the abutment point of the other edge of the key, whereby the axially adjacent tumbler disposition grooves have pitches differing from each other between the edges of the key.

5. The lock device according to claim 1, wherein the key has two sides formed with respective grooves extending along the central axis line of the key;
the key insertion hole of the key rotor is provided with a pair of guides which are fitted into at least one of the grooves thereby to guide the key inserted into the key insertion hole; and
the guides are configured to fit inside the grooves of both sides of the key in an interior of the key insertion hole when the key has been inserted into the key insertion hole and the guides are formed at symmetric positions with respect to the central axis line of the key.

6. The lock device according to claim 2, wherein the key has two sides formed with respective grooves extending along the central axis line of the key;
the key insertion hole of the key rotor is provided with a pair of guides which are fitted into at least one of the grooves thereby to guide the key inserted into the key insertion hole; and
the guides are configured to fit inside the grooves of both sides of the key in an interior of the key insertion hole when the key has been inserted into the key insertion hole and the guides are formed at symmetric positions with respect to the central axis line of the key.

7. The lock device according to claim 3, wherein the key has two sides formed with respective grooves extending along the central axis line of the key;
the key insertion hole of the key rotor is provided with a pair of guides which are fitted into at least one of the grooves thereby to guide the key inserted into the key insertion hole; and
the guides are configured to fit inside the grooves of both sides of the key in an interior of the key insertion hole when the key has been inserted into the key insertion hole and the guides are formed at symmetric positions with respect to the central axis line of the key.

8. The lock device according to claim 4, wherein the key has two sides formed with respective grooves extending along the central axis line of the key;
the key insertion hole of the key rotor is provided with a pair of guides which are fitted into at least one of the grooves thereby to guide the key inserted into the key insertion hole; and
the guides are configured to fit inside the grooves of both sides of the key in an interior of the key insertion hole when the key has been inserted into the key insertion hole and the guides are formed at symmetric positions with respect to the central axis line of the key.
